(19) United States
(12) Patent Application Publication
(10) Pub. No.: US 2015/0046320 A1
(43) Pub. Date: Feb. 12, 2015

(54) SERVICE PRODUCTIVITY AND GUEST MANAGEMENT SYSTEM

(71) Applicant: Tiply, Inc., Phoenix, AZ (US)

(72) Inventor: Timothy Lee BALDWIN, Chandler, AZ (US)

(21) Appl. No.: 14/315,310

(22) Filed: Jun. 25, 2014

Related U.S. Application Data
(60) Provisional application No. 61/863,154, filed on Aug. 7, 2013.

(51) Int. Cl. G06Q 20/10

(52) U.S. Cl. CPC G06Q 20/102
USPC 705/40

(57) ABSTRACT

The disclosed productivity and management system for service-oriented businesses provides a system for person-to-person payment using facial recognition techniques and mobile device location techniques. Person-to-person payment includes tipping or other electronic transfer of funds from a payor to a payee. In some instances, the system provides a guest with a grid populated with face photos of nearby business staff and allows the guest to select from among the grid to determine a payee. The grid is populated with photos based on the proximity of the staff's mobile device relative to the guest's device, or a tip-receiving history of employees at a location near the user's device. The system allows the payee's personal identity, apart from the payee's appearance, to be not known to the payor, and not disclosed to the payor, to complete the payment transaction.

### CROSS REFERENCE TO RELATED APPLICATION

This application claims the benefit of, and priority to, U.S. App. No. 61/863,154, filed Aug. 7, 2013, the entire disclosure of which is herein incorporated by reference.

### FIELD OF THE INVENTION

The present invention relates generally to electronic management systems deployed in service-oriented businesses, such as in restaurants and, more particularly, to a productivity system for businesses to provide guests with the ability to interact with their service staff via mobile phones or other devices.

### BACKGROUND OF THE INVENTION

Interactions between service staff (e.g., waiters or other service personnel) and guests at service-oriented businesses can be highly variable due to a number of factors, such as how crowded the business is, the number of guests assigned to a given service staff member, and various communication habits and barriers. These factors and a given guest's personal preferences can make it difficult to provide an optimum level of interaction between a guest and their assigned service staff member. Also, guests are sometimes reluctant to provide in-person feedback to management (both positive and negative) regarding their service experience. This makes it difficult for management to identify and correct problems in real-time or before those problems lead to diminished future business performance. Thus, there is a need for a system and method for facilitating, managing and monitoring guest interaction in a general service, setting, such as restaurants, bars, casinos, spas, salons, hotels or valet parking services.

Providing tips to service staff has generally been limited to cash payments at the time of service, or through indication of an additional charge on credit card transaction for the service. There is a need to provide additional approaches for tipping service staff.

### BRIEF SUMMARY OF PREFERRED EMBODIMENTS OF THE INVENTION

Present embodiments of the invention addresses the above-noted issues with advanced but easy-to-use guest-staff interfaces through use of a disclosed management system. The disclosed management system for service-oriented businesses facilitates desirable and optimized interactions between guests and their service staff, for example, waiting staff or other service personnel, or between guests and the restaurant establishment, using communications via mobile computing devices, including, but not limited to smartphones, tablets or wrist watches. Guests can use the communications system to notify a table waiter of specific requests or to perform certain tasks relating to the service transaction, including, but not limited to, requesting service, requesting a suspension of service because the guest does not want to be disturbed, requesting the check, providing service feedback, paying the check. The preferred embodiments can also act as a gateway to a restaurant's loyalty program, and can provide management and other guests with feedback on the service experience.

Present embodiments of the invention allow service-oriented businesses to employ superior service and guest interaction options without introducing a fundamentally new operation or process to the usual service transaction. For example, the system and processes allow current table and guest service arrangements of a restaurant to be augmented to improve interactions without overhauling the restaurant's service process.

Present embodiments of the invention provide a system for person-to-person payment using facial recognition techniques. Person-to-person payment includes tipping or other electronic transfer of funds from a payor to a payee. The system allows the payee's personal identity, apart from the payee's appearance, to be not known to the payor, and not disclosed to the payor, to complete the payment transaction.

Present embodiments of the invention provide a system for person-to-person payment using mobile device location techniques. In some instances, the system provides a guest with a grid populated with face photos of nearby staff, which can be determined using parameters such as the proximity of the staff's mobile device relative to the guest's device, or the proximity of the location of previous tipping transactions, and allows the guest to select from among the grid to determine a payee.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

Preferred embodiments of the present invention are illustrated by way of example, and not by way of limitation, in the figures of the accompanying drawings and in which like reference numerals refer to similar elements and in which:

FIG. 1 is a flow diagram illustrating an example of guest interaction with the management system, according to some embodiments.

FIG. 2 shows an example of a guest user interface for inputting system commands, according to some embodiments.

FIGS. 3-4 show an example of a guest user interface for providing feedback to a business, according to some embodiments.

FIG. 5 is a diagram illustrating connections between the management system and other computing resources on a network, according to some embodiments.

FIG. 6 is a flow diagram showing a process executed by the management system for using facial recognition techniques to facilitate person-to-person payment, according to some embodiments.

FIG. 7 is a flow diagram showing a process executed by the management system for using location techniques to facilitate person-to-person payment, according to some embodiments.

FIG. 8 shows an example of a staff user interface for receiving notifications from the management system, according to some embodiments.

FIG. 9 shows an example of a staff user interface for inputting responses to the notifications from the management system, according to some embodiments.

FIG. 10 shows an example of a management/administrator user interface for configuring service nodes, such as tables in a restaurant, according to some embodiments.

FIGS. 11-12 show examples of management/administrator user interfaces for configuring service nodes, such as grouping and color coding of tables in a restaurant, according to some embodiments.

FIG. 13 shows an example of a management/administrator user interface for configuring service nodes, showing a graphical mapping between user interface elements and a restaurant floor plan.

FIG. 14 is a diagram illustrating connections between components in a wireless local area network for deployment inside a business premises, according to some embodiments.

FIG. 15 is a diagram that illustrates a computer system upon which some embodiments may be implemented.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION OF PREFERRED EMBODIMENTS OF THE INVENTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention. These embodiments are not intended to limit the present invention to any specific example, environment, application, or particular implementation described herein. Therefore, descriptions of these example embodiments are only provided for purpose of illustration rather than to limit the present invention.

The guest-side of the management system can be configured as an application executing on a mobile device of an end-user, such as a guest of a business employing the management system. Mobile devices include, but are not limited to, a smartphone or tablet device, devices using the iOS or Android operating systems, or other computing device capable of wireless mobile communications. However, tableside computing kiosks can also be provided in lieu of or in combination with a user's device. In some embodiments, the user interacts with the system via the graphical user interface (GUI) on the device. In some embodiments, user input is facilitated by a touch screen, voice activation and input, and/or a keypad (virtual or physical) on the device. The guest application on the device comprises native executable instructions stored on the physical memory in the user's phone, or can be provided via a web-based application (e.g., HTML) accessible on the user's phone via a web browser interface. The guest application running on the user's phone can communicate with the business staff via Bluetooth, Wi-Fi (e.g., 802.11x protocols), cellular data protocols (e.g., LTE, CDMA, GSM), or other wireless communications methods.

The management-side of the management system can be configured as an application stored on physical memory in a computer, tablet or smartphone of the management user, and in some embodiments, the management side comprises a wireless local area network of mobile devices, which is in communication with a management server.

“ChekPleez” as referenced in the description below and in the figures refers to an example of a management system according to some embodiments of the present invention. This name is used for illustrative and demonstrative purposes, and does not limit the naming or functionality of the systems, devices and methods disclosed herein. In addition to implementation at restaurants, the embodiments described herein can be used in other service areas or industries, including casinos, spas, hotels, valet parking, movie theaters, hospitality environments, and other businesses benefiting from the features of the embodiments.

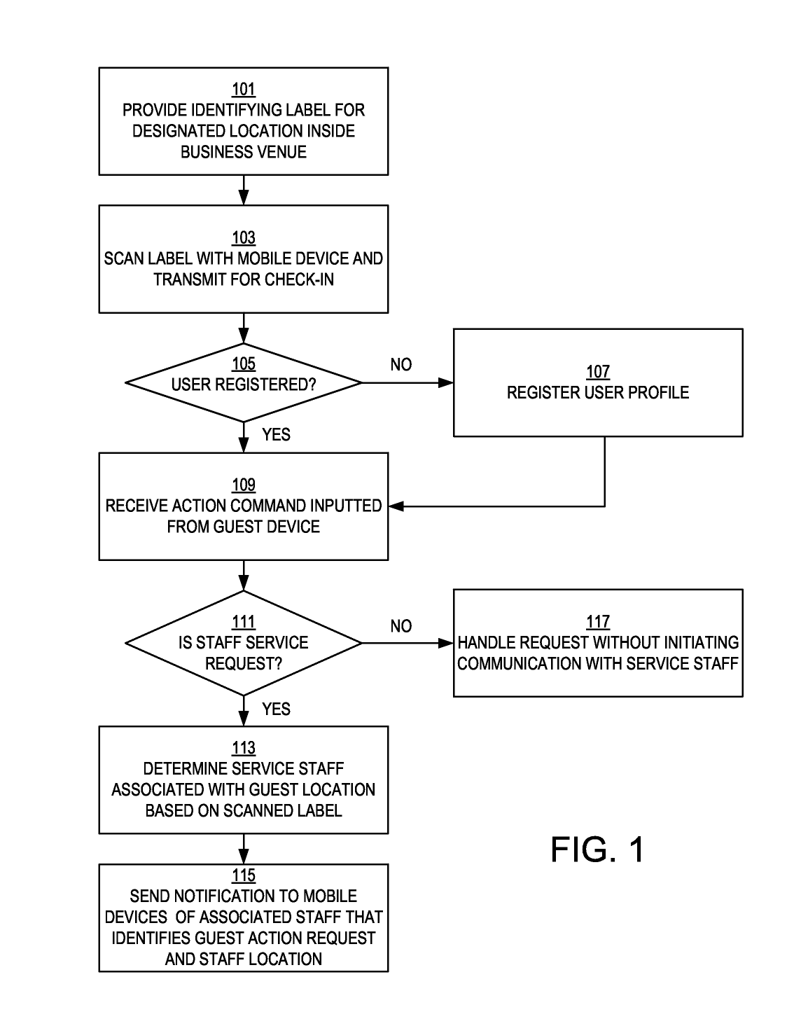

FIG. 1 is a flow diagram showing an example of a guest's interaction with the management system, according to some embodiments. At step 101, a label is provided for a table or bar seat where a guest is seated. In some embodiments, ChekPleez QR code label is provided at each table, seat, or other designated location. Labels can be in several forms such as fixed asset labels, marketing slicks, or business cards, and may include information about the ChekPleez service in addition to any other customized marketing information included by the restaurant or other service-oriented establishment. At step 103, a guest launches the ChekPleez mobile application and scans the table or seat QR code to initiate communications with the management system and to transmit the service-oriented business's identity and the guest's location within the venue to the management system, also referred to herein as a “check-in.” In addition to QR code initiation, the user can be instructed where to find and download the user application via a mobile application store or other online resource. In addition, other systems, device and technology can be employed to initiate the guest interface, or to enable the guest to check-in at a particular table or location. Examples of such technologies include near-field communication (NFC), RFID tags, check-in software options.

In some embodiments, if the guest does not already have the ChekPleez Guest application stored on their smart phone or other mobile device, the guest can scan the QR code with their phone and then follow the instructions to download the free ChekPleez Guest mobile application. If the guest already has the ChekPleez Guest application, then scanning the QR code can register the guest to that particular table. At step 105, if it is determined that the guest is a first-time user, then at step 107, the guest will create a user profile, and enter the user's information into the application interface for registering the user with the management system. The profile may be used by the service-oriented business for loyalty purposes based on guest registrations.

At step 109, when a guest has a particular need, desires a particular service, wants to pay the check, or comment on service, the guest can open up the ChekPleez Guest application and select the appropriate action button. At step 111, it is determined if the action button input is a request that requires attention from service staff. If so, at step 113, service staff that is associated with the guest's table or seat, as identified from the scanned label, is determined. At step 115, the associated staff is notified on one or more staff mobile devices, such as a linked watch or other mobile device, of the guest's request. The service staff can act accordingly to service the request. If at step 111, it is determined that the action button input is not a request that requires attention from service staff, then at step 117, the management system handles the requested action without sending any notification to the service staff.

According to some embodiments, any guest at a table can register and make a request to the service staff member. The management system also allows for any guest to partially pay for a portion of a check of a table, thereby allowing diners at the same table to split a check without burdening a waiter or cashier with check-splitting instructions and requests.

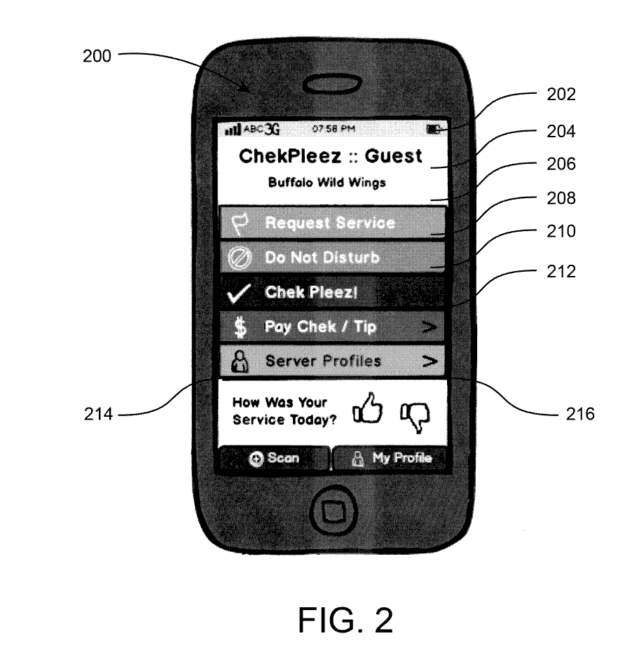

FIG. 2 shows an example of a guest user interface 200 for inputting system commands, according to some embodiments. Guest user interface 200 includes several action buttons, which when selected, sends a command to the management system for handling. Action buttons include service request button 202, do not disturb button 204, check request button 206, check payment or tip payment button 208, staff profile view request button 210, service rating buttons 212, scan button 214, and user profile access button 216, or buttons for sending other service commands or accessing other application features.

According to some embodiments, the use of service request button 202, do not disturb button 204, and check request button 206 will trigger a notification to the device of one or more staff members associated with the guest's location, such as in steps 111-115 described with reference to FIG. 1 above. The use of check payment or tip payment request button 208, staff profile view request button 210, service rating buttons 212, scan button 214, and user profile access button 216, generally do not require live action by a staff member, and in such configurations, and the management system will process these request without sending notification to any staff device.

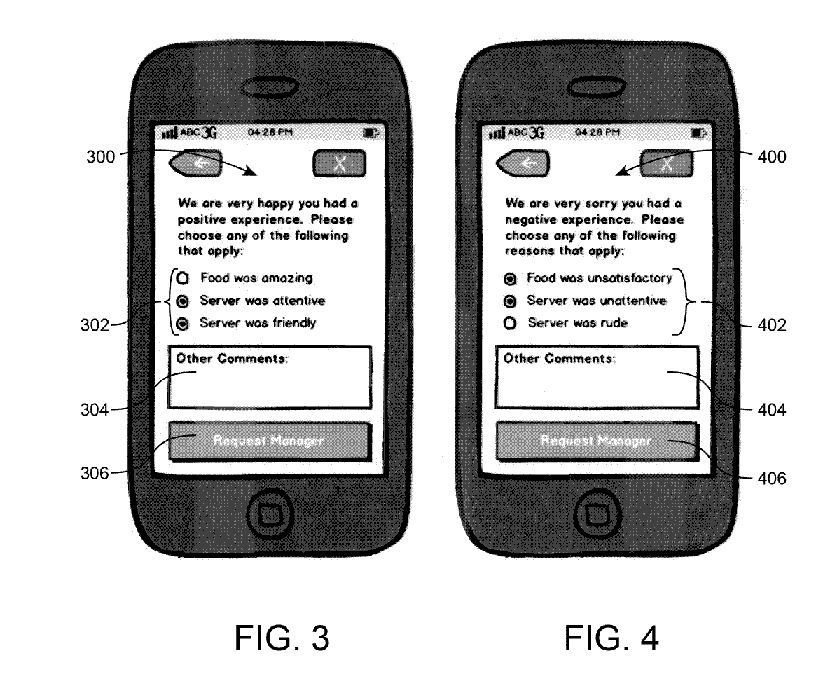

FIG. 3 shows an example of a positive feedback guest user interface 300, and FIG. 4 shows an example of a negative feedback guest user interface 400, according to some embodiments. Guest user interfaces 300 and 400 may be launched by the positive button or the negative button of the service rating buttons 212, respectively. For example, a guest rates the service by selecting either the “thumbs up” or “thumbs down” button shown in FIG. 2, which causes the application to navigate to the corresponding comments screens 300 or 400. In some embodiments, guests can select from one or more pre-set reasons or language 302 or 402 from the comments screen for either the good or bad service, respectively, in addition to adding custom comments at comments box 304 or 404. Pre-set reasons can be set up by a service-oriented business's administrator within the admin web application. Guests can also select the “Request Manager” button 306, which will cause the management system to send a notification, for example, to a staff device identified as the manager's device, or to one or more staff devices with a notification that a manager has been requested to report to the sending guest's location. A service-oriented business may also use received guest comments to automatically alert or flag a manager regardless of whether a guest selects the “Request Manager” button. Further, the rating input can include options to interact directly with user review sites or services, such as Yelp, Foursquare or like services.

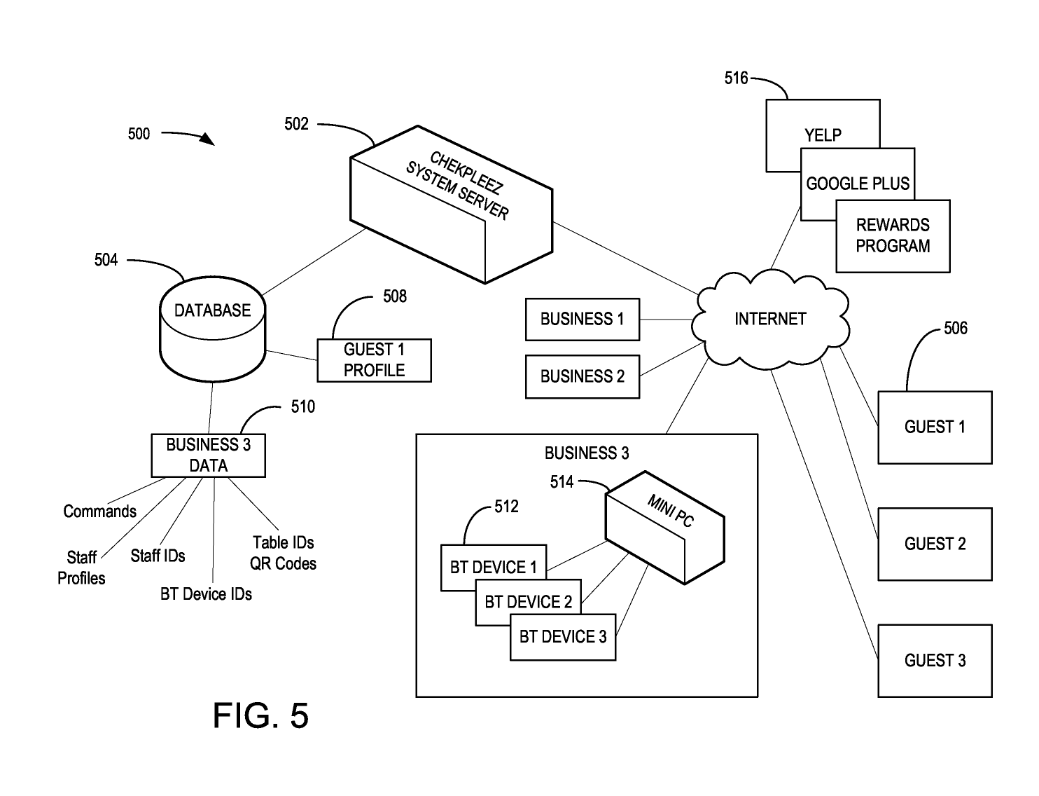

FIG. 5 is a diagram illustrating an example of connections between the management system and other computing resources on a network for enabling the interactions described above, according to some embodiments. According to some embodiments, management system 500 includes system server 502. System server is communicatively coupled to database 504. System server 502 is configured to receive label scans and action requests from guests' devices running the management system client application, such as device 506 of Guest 1. In some embodiments, device 506 includes a table computing kiosk that provides the guest client application.

In some embodiments, system server 502 maintains database 504 for storing business and guest data, including guest profile data 508 and business data 510. Business data includes command data for handling certain action requests, staff profile data, staff identification data, Bluetooth device identification data, label data for the business, pairing data for associating staff ID and staff device, location assignment data for associating staff ID to label data, and other business-specific data. System server 502 is configured to determine further action in response to the action requests, including sending notification to a staff device, such as one of staff devices 512. In some embodiments, a staff device is associated with a particular staff ID, and a particular staff ID is assigned to a location within a business venue that is specified by an identifier such as a table identifier maintained by database 504.

In some embodiments, system server 502 is coupled via the Internet to client devices at the business venue, including a mini computer 514 running an application for receiving and transmitting communications to the one or more Bluetooth-enabled staff devices 512, such as a watch or a tablet, and for communicating with the system server 502 via the Internet. In some embodiments, mini computer 514 and staff devices 512 are communicatively coupled on a wireless local area network or using other wireless networking techniques.

In some embodiments, system server 502 routes action requests received from client devices 506 to feedback services 516, such as Yelp, Google Plus, or other 3rd party rewards or review program.

With further reference to FIG. 2, guest user interface 200 provides check payment or tip payment button 208 for submitting payment via the management system, according to some embodiments. In some embodiments, interface elements are provided when payment button 208 is selected to specifically direct tips to one or more service staff or other business personnel. For instance, the tip amount designated when paying the bill, can be divided up to multiple personnel (host, multiple service staff, etc.), or can simply be directed to a single service staff member that has waited on the guest. Interface elements are also provided when payment button 208 is selected to pay the check by an express payment option without requiring any staff to be alerted to deliver a check to the guest. The express payment option can be completed with the guest's device and can operate through software specifically tied to the establishment's server or backend system, or via a third-party application or service adapted to provide remote checkout or payment options for payment transactions (e.g., PayPal, Square, Google Wallet, Apple's Passbook, etc.).

In one embodiment, facial recognition can be implemented to facilitate tipping and other forms of payment. The process can include holding up a mobile phone with the guest interaction software or application open such that the service staff member's face or likeness is captured in the application. The application will process the captured image through recognition match software or subroutines to match the image against a learned or programmable data store of images. If the subject person (service staff member) is already registered within the application or service, the application can match the subject person and then prompt the user (tipper) for the amount he would like to tip. The application could then send out a notification (a text message, email, device notification, etc.) to the subject person (service staff member) to notify him that he has been tipped, who tipped him, the tip amount, and the like. If the subject person is not registered in the application, then the application can save the image and prompt for the service staff member's email address, phone number, contact information, etc., so the service staff member gets notified that a tip is waiting for him or her. The application can then prompt for the tip amount and send out a notification email to the service staff member's email address or other means of contact. When the service staff member receives the email, he or she can click on the web link to download the mobile application and register in order to receive the tip. Once registered, the service staff member's image will already be in his or her profile and learned within the application for the purpose of tipping via facial recognition.

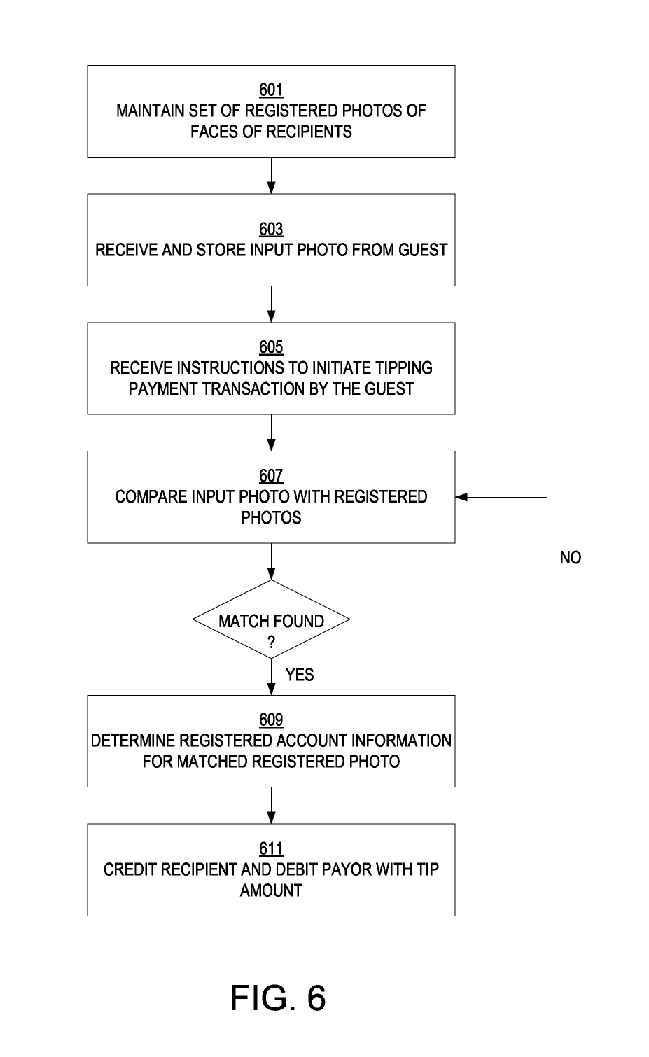

FIG. 6 is a flow diagram showing a process executed by the management system for using facial recognition techniques to facilitate person-to-person payment, according to some embodiments. Person-to-person payment includes tipping or other electronic transfer of funds from a payor to a payee whose personal identity, apart from the payee's appearance, may not be known to the payor, and not disclosed to the payor. At step 601, the system maintains a set of registered photos of faces. In some embodiments, the registration of faces includes obtaining at least two views of a face (e.g., front view, slightly turned right, slightly turned left), and identifying information for the person to which the face belongs. In some embodiments, the registered faces are associated with staff, or other prospective payee, who has an account configured to receive payment from a payor. In some embodiments, the identifying information of the registered face is not revealed to the payor.

At step 603, the system receives and stores an input digital photo of a face for identifying a recipient of a personal payment, such as a tip. For example, the input photo is of a face of a staff member sent by a guest at a service-oriented business. In some embodiments, the guest opens a mobile tipping application from a mobile device to take one or more photos of the staff member to be tipped. The tipping application may be configured to automatically take multiple photos once it detects a face with the mobile device's camera.

At step 605, the system receives instructions to initiate a payment transaction by the guest, and associates the input photo with the pending payment transaction. In some embodiments, the instructions to initiate a payment transaction includes a payor's identifying information and payment method information, or any information necessary for the system to initiate an electronic transfer of funds from the payor. In some embodiments, the guest's tipping application provides dollar amount buttons for easy payment, where the amounts include, for example, predetermined fixed amounts, or amounts related to the check total. In some embodiments, the application calculates suggested tipping amounts based on the guest's check, which may be automatically received from the managements system. In some embodiments, the tipping amount is manually inputted by the guest. The guest can include a text message that the system can forward to the recipient. In some embodiments, the initiated transaction is associated a temporary transaction ID, and the photo, the tipping amount, and the text messages are associated with the temporary transaction ID. In some embodiments, upon sending the payment initiation and the photo, the tipping application displays a confirmation screen. The confirmation screen provides the advantage of allowing a guest to present the screen to the recipient to provide live notification of the payment.

At step 607, the system periodically compares the input photo with the system's registered photos of faces to determine a match between the input photo and a particular registered photo. In some embodiments, the input photo is identified and maintained persistently by the system as an unmatched photo with a pending credit until the tipping transaction is terminated by successful payment, or other terminating event, such as cancelation of the payment or a time-out condition.

At step 609, if a photo match is found, the identifying information associated with the matched registered photo is retrieved to determine the registered account information for the recipient. If a photo match is not found, step 607 repeats until either a photo is found, or other terminating condition is met, such as a cancelation of the pending payment transaction, or a time-out condition.

At step 611, the system causes an account associated with the account information to be credited while debiting the payor's associated payment method. In some embodiments, the recipient's credits are aggregated before a recipient's bank account is deposited with the payments. For example, the debited sums for a pay period are held in trust by the management system's escrow account and deposited to the recipient's bank account, or other payment receiving method, at the end of a pay period.

In some embodiments, the input digital photo and the instructions to initiate a payment transaction received at steps 603 and 605 are not received shortly after input of the instructions by a user into a client device. Instead, a client device may be offline when a user configures the instructions to send input digital photo and to initiate a payment transaction, and the instructions may be sent to and received at the server at a later time when the client device restores network connectivity.

In addition, QR Codes or like technology can be used to facilitate tipping. A registered user can elect to receive QR coded business cards, labels, and pins that display a QR code. People can scan the QR code (e.g., identifying and linking to a particular service staff member) within the application, enter a tip amount, and send a tip to the subject person (service staff member).

Location search methods and techniques can also be used to enable tipping and payment. The application can identify people registered to receive tips (service staff) within a geographical vicinity of a user (the tipper), and the user will see which, if any, business locations are nearby that have people associated with the locations to receive tips. Geo-fencing or like technology can be employed to specifically and automatically identify service staff registered or available to receive tips within the bounds of the business location. As such, in certain embodiments, simply entering an establishment will provide the user with an applicable list of service staff via the guest interaction software or application. The list can be updated and maintained in real-time based on the service staff on duty, and can keep the user application up-to-date within the defined area.

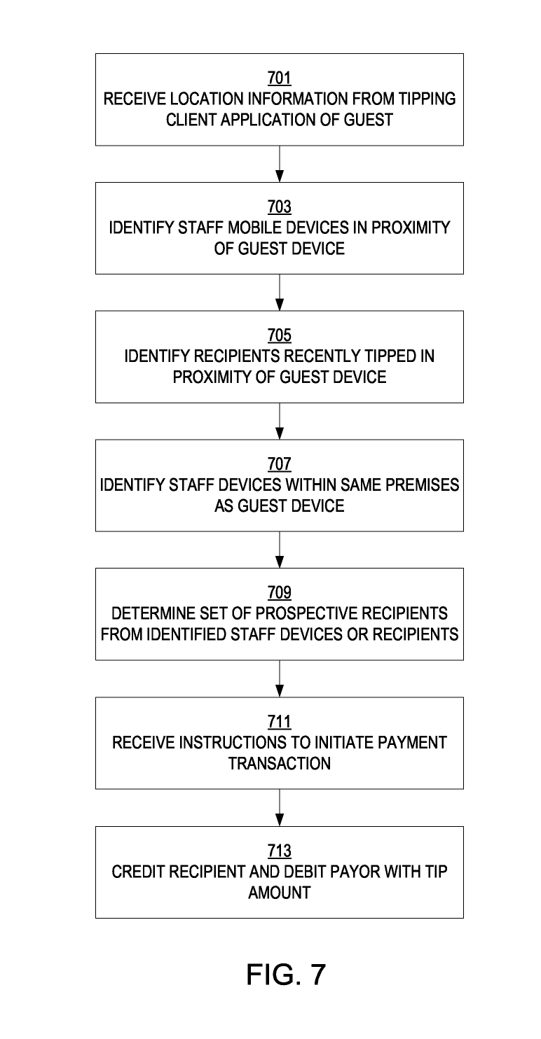

FIG. 7 is a flow diagram showing a process executed by the management system for using location techniques to facilitate person-to-person payment, according to some embodiments. At step 701, the system receives location information from a tipping client application from a guest. Location information includes longitude and latitude data from determined from the guest's mobile device. At step 703, the system identifies staff mobile devices that are in proximity to the location information received. In some embodiments, proximity is determined based on a distance range or radius from the guest's mobile device. In some embodiments, proximity is determined from identifying a geo-fenced area associated with the guest device, and identifying staff mobile devices within the same geo-fenced area. Geo-fenced areas may include boundaries of a service-oriented business, for example, a table group within a restaurant. At step 705, the system uses historical tipping records for identifying previous recipients of tips in tipping transactions that occur at locations in proximity of the location information received. For example, the system identifies a recipient who received a tip from a previous tipper who was previously in proximity to the location information received. Here, the recipient will be identified regardless of whether he or she is currently in proximity of the guest, and regardless of whether his or her device is currently in proximity of the guest. In other words, the recipient may be absent from the proximity from the location information or geo-fenced area, and still be identified in step 705. At step 707, the system identifies the premises of the location of the guest device, and identifies staff devices that are determined to be within the same premises.

At step 709, the staff devices or recipients identified at steps 703-707 are used to determine a set of prospective recipients for a tip, and the set of prospective recipients are provided by the system to the guest's device for selection. In some embodiments, the guest's tipping application populates a graphical user interface with registered photos or names of the set of prospective recipients to assist the guest in identifying a recipient for the tip. For example, photos of the faces of the prospective recipients are arranged in a grid on the guest's device to facilitate easy recognition and selection by touching one of the faces. In some embodiments, data relating to the location, or the recentness of the prospective recipient's last tip, are used to determine the order of display of the photos and/or names.

At step 711, the system receives instructions to initiate a payment transaction by the guest to a recipient selected from the set of prospective recipients. In some embodiments, the recipient is selected by the guest from the graphical user interface of the tipping application. In some embodiments, the instructions to initiate a payment transaction includes a payor's identifying information and payment method information, or any information necessary for the system to initiate an electronic transfer of funds from the payor. In some embodiments, the guest's tipping application provides dollar amount buttons for easy payment, where the amounts include, for example, fixed amounts, or the application calculates suggested tipping amounts based on the guest's check, which may be automatically received from the managements system, or may be manually inputted by the guest. The guest can include a text message that the system can forward to the recipient. In some embodiments, the initiated transaction is associated a temporary transaction ID, and the tipping amount, and the text messages are associated with the temporary transaction ID. In some embodiments, upon sending the payment initiation and the selected recipient from the set of prospective recipients, the tipping application displays a confirmation screen. The confirmation screen provides the advantage of allowing a guest to present the screen to the recipient to provide live notification of the payment.

At step 713, the system causes an account associated with the recipient to be credited while debiting the payor's associated payment method. In some embodiments, the recipient's credits are aggregated before a recipient's bank account is deposited with the payments. For example, the debited sums for a pay period are held in trust by the management system's escrow account and deposited to the recipient's bank account, or other payment receiving method, at the end of a pay period.

In some embodiments, when the guest's tipping application populates a graphical user interface with registered photos or names of the set of prospective recipients at step 709, the populated user interface persists when a client device is offline. In such instance, client device may be offline when a user configures the instructions to initiate a payment transaction, and the instructions may be sent to and received at the server at a later time when the client device restores network connectivity.

While the above description includes examples of steps being executed in a particular order, it is understood that steps executed in a different order, or concurrently, will not depart from the spirit and scope of the invention. Further, it is understood that one or more of the steps is not required for the some embodiments of the invention. For example, one or more of steps 703-707 for identifying staff devices or recipients may be omitted to without affecting the system's ability to determine a set of prospective recipients for a tip.

Again, additional third party payment options, as disclosed herein, can be employed during various steps of the tipping and payment process. Service-oriented business's managers or administrators can access current and past staff profile data when conducting service staff member reviews, or when hiring new service staff if they choose to have their service staff register staff profiles in the ChekPleez system.

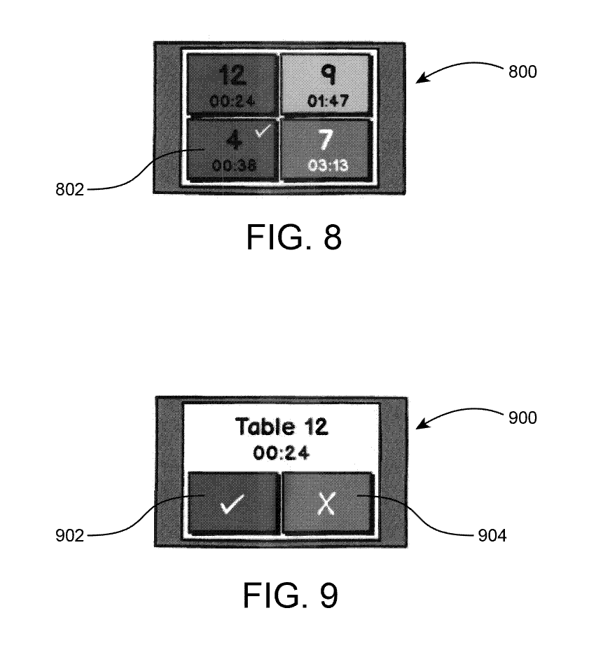

FIG. 8 shows an example of staff notification interface 800, according to some embodiments. With reference to FIG. 2, when a guest selects the “Request Service” action button 202, the guest's table number appears on grid interface 800 displayed on the service staff member's watch and/or on service staff station tablets, as shown in FIG. 8. The service staff member can respond accordingly to the notification, including providing requested service to the table.

Once the service staff member commits to servicing the table, the service staff member selects the table number on either the tablet's or the watch's touch screen, such as table icon 802, which may be configured to clear out the request with one touch on the applicable icon. The table icons can be color coded (or image, grey-scale distinguished) to represent different service staff member assignments. The icons can also be highlighted or change color in order to emphasize an aspect of service to the service staff member, such as an excessive wait time. In addition, if the notification from the user provides details of the requested service (e.g., need a drink refill, more napkins, utensils, condiments, etc.), the notification icon can be selected to switch to a new screen or display window to further display the specifics of the request.

With reference to FIG. 2, when a guest selects the “Chek Pleez!” or like action button 208, a check mark or similar indicia can appear next to the table number on the service staff member's mobile display, such as the check mark for table icon 802. Grid cells can optionally provide information relating to a particular table, including if a table's request is aged by showing different background colors that indicate age and/or by cell animations and age timers, as shown in interface 800.

In some embodiments, different preferred grid configurations are available for a Smart Watch: for instance, four cells and six cells. The grid configurations can be set to automatically shift from one configuration to another to match the guests' request demand.

FIG. 9 shows a staff response interface 900 on a staff mobile device, according to some embodiments. For any of the cell configurations, the staff application interface may be configured to require a two-click selection process for clearing out a request. In this case, a table will not be cleared until the service staff member has confirmed the instructions to clear the request on the second screen, by touching check mark icon 902 to assist in preventing inadvertent resets. Inadvertent touches on interface 800 can be dismissed by touching X icon 804.

Depending on the management's preference, a service staff member will either wear a ChekPleez service staff smart watch, regularly monitor a ChekPleez smart tablet fixed at serving stations, utilize a combination of both, or use any device adapted to communicate and interact with the user device. In either case, the smart watch, tablet or device receives staff notifications via wireless communication means as discussed herein. For those embodiments including a smart watch device or hardware, the watch can include various means of providing notifications and accepting inputs. For instance, the watch can vibrate as a notification, the service staff member can shake or quickly move (e.g., triggering an accelerometer or gyro in the device) to view or even respond to a guest request, actuate a physical or virtual button or set of buttons to provide input, initiate voice commands to provide input, or receive input via a touch screen. Other input and notification options are further envisioned depending on the software and hardware implemented and can be employed without deviating from the spirit and scope of the present invention.

The system will now be described with respect to the service-oriented business's manager/administrator, according to some embodiments. After signing up as a ChekPleez customer, the restaurant will get administrative access to the ChekPleez website and mobile application as well as receive watches and/or tablets from ChekPleez affixed with ChekPleez QR code asset labels.

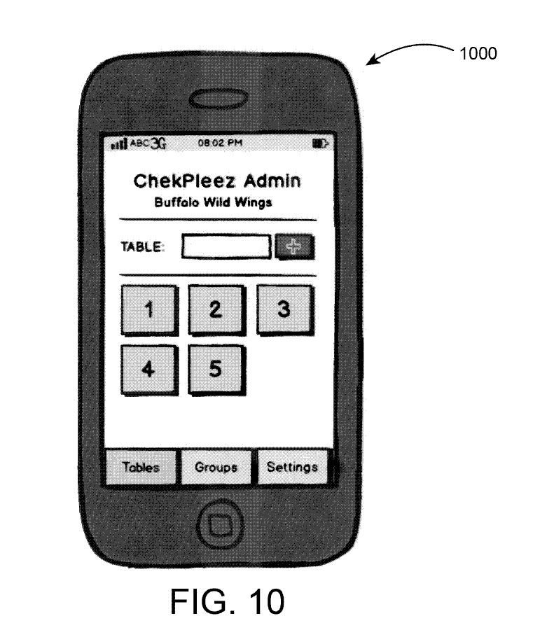

FIG. 10 shows an example of administrator user interface 1000, according to some embodiments. The administrator user interface 1000 of the ChekPleez Admin mobile application, or alternatively of the ChekPleez website, allows an administrator to add table numbers to the management system for the service-oriented business, and to associate the table numbers with the table's designated QR Code by scanning the table's QR Code label.

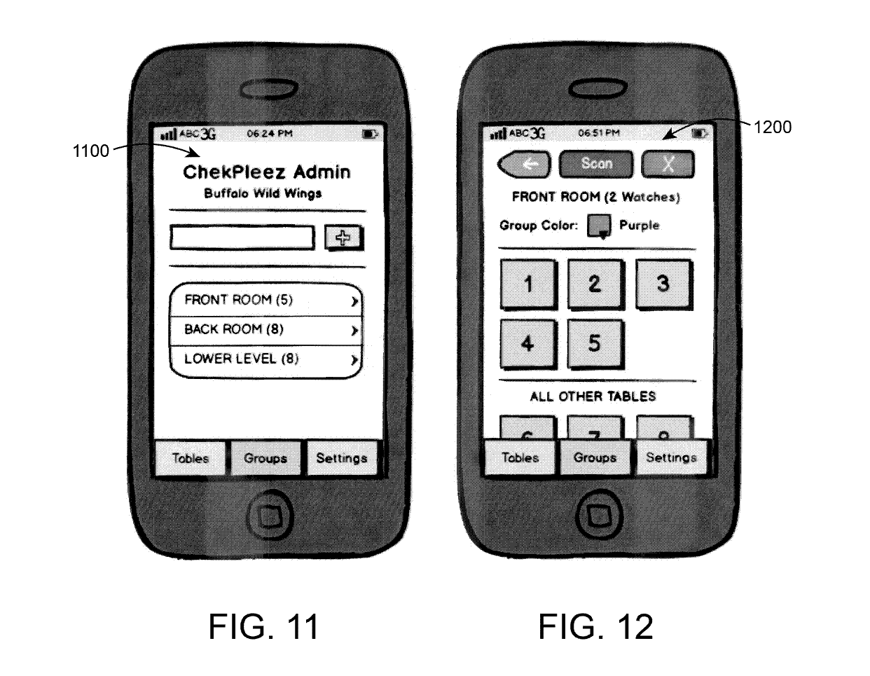

FIG. 11 shows an example of administrator user interface 1100 for table groups, according to some embodiments, where the administrator can also add Table Groups within the application such as “Front Room” and associate tables to the groups within the application. Then, if it is desired to only show the tables that belong to particular groups on designated ChekPleez devices, the administrator uses the ChekPleez Admin app to scan a watch or tablet QR Code to associate it with a particular table group. ChekPleez devices can be associated with multiple table groups.

FIG. 12 shows an example of the use of colors to classify and organize tables in administrator user interface 1200, according to some embodiments. For example, the administrator assigns a color to a group name in the ChekPleez system, and uses colored stickers or other indicia provided by ChekPleez to affix to the back of a watch or tablet to indicate the group color that matches the group name in the ChekPleez system. This approach can make it easier to distribute devices to the correct service staff and return devices to their proper storage areas.

An administrator can control how the ChekPleez Smart Watch and Smart Table applications function by configuring settings from within the ChekPleez website or mobile application. The color and animation of grid cell aging, expiration time for a guest's request, and two-click request clearing described above are some of the settings an administrator can configure, according to some embodiments.

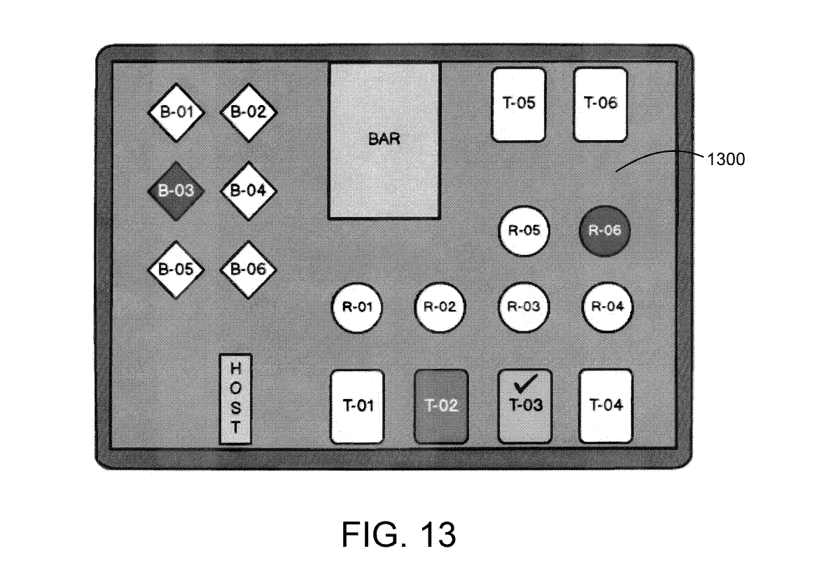

FIG. 13 shows a further administrative user interface 1300 to add and manage table groups on a larger interface, such as on a tablet computer, in accordance with the unique configurations and setup of the restaurant or service establishment.

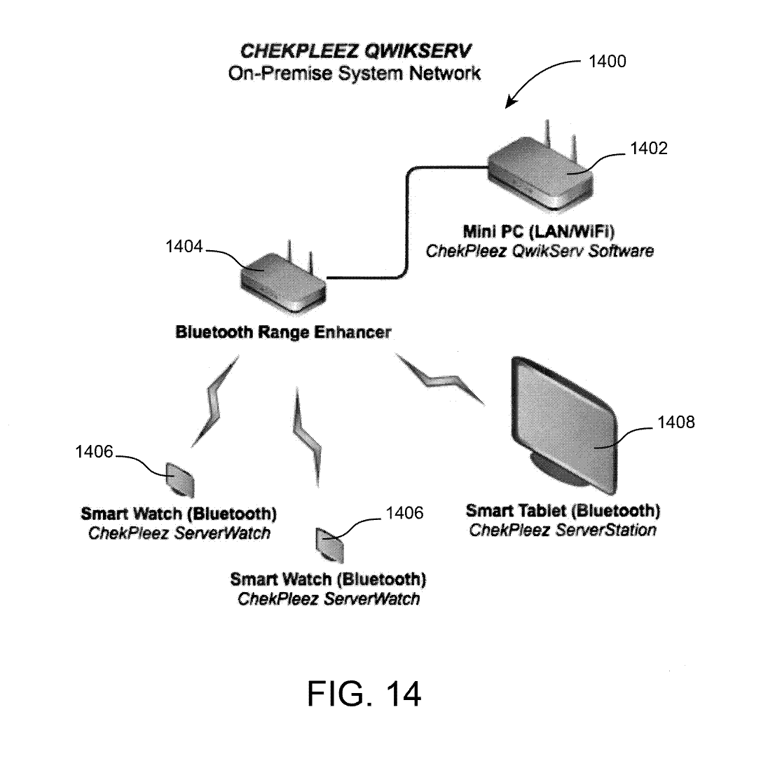

FIG. 14 shows a diagram of the on-premise system network 1400 for a business, according to some embodiments. In addition to ChekPleez web and mobile applications, each service-oriented business location can include a simple system 1400 of ChekPleez hardware to be networked on-premise. Each location comprises one mini computer 1402 running Android or a similar operating system and the ChekPleez QwikServ Mobile Dispatcher application, a Bluetooth signal range enhancer 1404 that connects to the computer 1402 (e.g., via USB), and a plurality (e.g., up to 30) of floor devices comprised of ChekPleez watches 1406 and tablets 1408 that run the ChekPleez Server and ChekPleez Station applications, respectively, and connect to the mini PC 1402 via Bluetooth. The ChekPleez system can be shipped to a business pre-configured as a plug-n-play, pre-configured, solution for the business. The system can be configured via on-premise internet connectable to the ChekPleez website by a designated installer or the restaurant system administrator.

In one preferred embodiment of a business method employing the system described herein, the system owner retains ownership of all the ChekPleez system hardware and software. Therefore, all businesses employing the ChekPleez system are subscribers under a contract with the owner company. An initial setup can be charged a fee for new accounts per location and then monthly payments for the ChekPleez base system package and additional watches and tablets. The ChekPleez base system comprises a mini PC, a Bluetooth signal enhancer, and at least one watch, tablet, or other mobile device. Additional fees can be charged per month for each additional tablet, watch, or device, over that initial one (or other base number).

In the event that a customer of a service-oriented business decides to cancel the ChekPleez subscription service for one or more locations, the customer can be charged a pro-rated fee per canceled location beginning from a predefined number of days after shipment. In certain embodiments, no pre-notice is required or fees imposed for a customer to cancel a subscription after the initial contract duration has been fulfilled. On-premise hardware can be shipped back to the owner and the customer will be charged the pro-rated fee until the owner has received all of the on-premise equipment.

Service-oriented businesses that wish to be customers can go to the ChekPleez website to subscribe to the ChekPleez service, setup their account and manage their account. All initial and monthly fees can be directly pulled from the service-oriented business's bank account. During setup, businesses can optionally pay for installation services provided through ChekPleez or have the ChekPleez system shipped to each business location for self-setup.

Service-oriented businesses have access to ChekPleez guest comments, Guest/Service staff member activity and data through the ChekPleez administration website, or administrative devices or PCs on-site. ChekPleez software and services can keep track of all activity for each location and make the information available to management to view online, on-site, or through file downloads. All reports and downloads can be parameterized by table, table groups, service staff, and date ranges including pre-set ranges for daily, weekly, monthly, quarterly, and annual periods.

Through the ChekPleez website, an administrator can configure the ChekPleez system to integrate with popular third-party loyalty systems, e.g., Yelp or like services and systems. Guest registrations can also be downloaded as files and used for the service-oriented business' internal loyalty system. Features such as cloning a service-oriented business's location settings is generally only performed through the ChekPleez website.

In the event that a guest registers at a table different from where the guest is seated and makes a false request to a service staff member, a service staff member can temporarily freeze requests for a particular table. Also, the service staff member can flag the false request so the requesting user gets a notification of the occurrence and can optionally be banned from using the system at that particular service-oriented business per the business management's system setting preference.

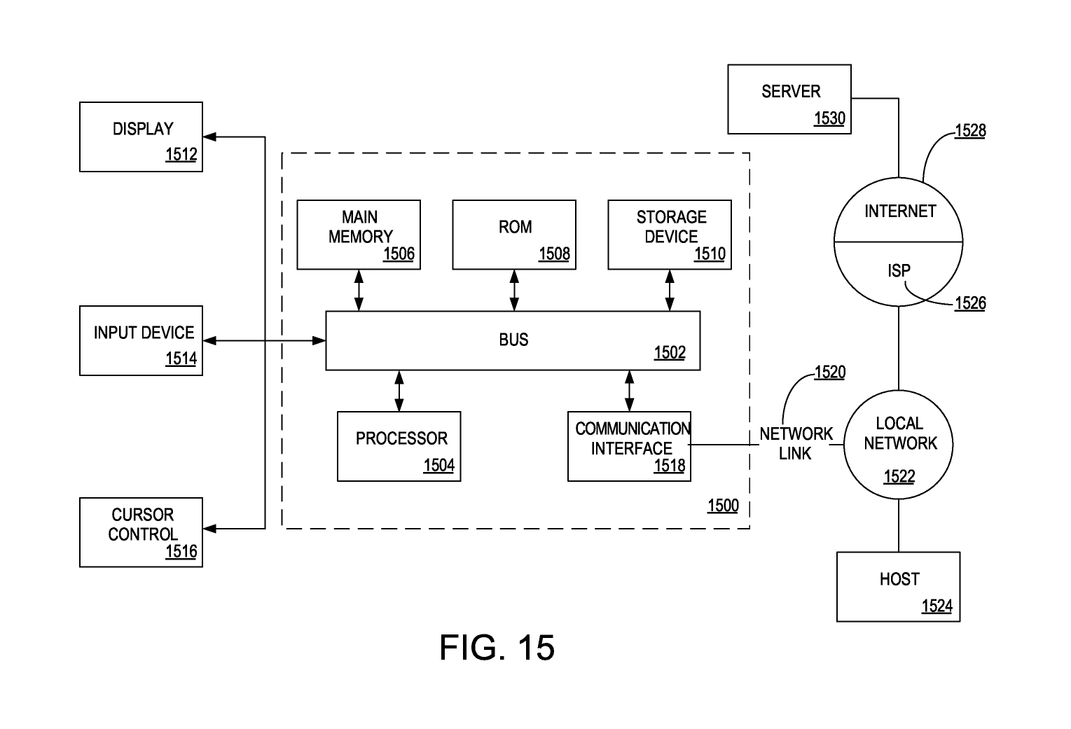

FIG. 15 is a block diagram that illustrates a computer system 1500 upon which some embodiments may be implemented. Computer system 1500 includes a bus 1502 or other communication mechanism for communicating information, and a processor 1504 coupled with bus 1502 for processing information. Computer system 1500 also includes a main memory 1506, such as a random access memory (RAM) or other dynamic storage device, coupled to bus 1502 for storing information and instructions to be executed by processor 1504. Main memory 1506 also may be used for storing temporary variables or other intermediate information during execution of instructions to be executed by processor 1504. Computer system 1500 further includes a read only memory (ROM) 1508 or other static storage device coupled to bus 1502 for storing static information and instructions for processor 1504. A storage device 1510, such as a magnetic disk, optical disk, or a flash memory device, is provided and coupled to bus 1502 for storing information and instructions.

Computer system 1500 may be coupled via bus 1502 to a display 1512, such as a cathode ray tube (CRT) or liquid crystal display (LCD), for displaying information to a computer user. An input device 1514, including alphanumeric and other keys, is coupled to bus 1502 for communicating information and command selections to processor 1504. Another type of user input device is cursor control 1516, such as a mouse, a trackball, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane. In some embodiments, input device 1514 is integrated into display 1512, such as a touchscreen display for communication command selection to processor 1504. Another type of input device includes a video camera, a depth camera, or a 15D camera. Another type of input device includes a voice command input device, such as a microphone operatively coupled to speech interpretation module for communication command selection to processor 1504.

Some embodiments are related to the use of computer system 1500 for implementing the techniques described herein. According to some embodiments, those techniques are performed by computer system 1500 in response to processor 1504 executing one or more sequences of one or more instructions contained in main memory 1506. Such instructions may be read into main memory 1506 from another machine-readable medium, such as storage device 1510. Execution of the sequences of instructions contained in main memory 1506 causes processor 1504 to perform the process steps described herein. In alternative embodiments, hard-wired circuitry may be used in place of or in combination with software instructions to implement the invention. Thus, embodiments are not limited to any specific combination of hardware circuitry and software. In further embodiments, multiple computer systems 1500 are operatively coupled to implement the embodiments in a distributed system.

The terms “machine-readable medium” as used herein refer to any medium that participates in providing data that causes a machine to operate in a specific fashion. In an embodiment implemented using computer system 1500, various machine-readable media are involved, for example, in providing instructions to processor 1504 for execution. Such a medium may take many forms, including but not limited to storage media and transmission media. Storage media includes both non-volatile media and volatile media. Non-volatile media includes, for example, optical disks, magnetic disks, or flash memory devices, such as storage device 1510. Volatile media includes dynamic memory, such as main memory 1506. Transmission media includes coaxial cables, copper wire and fiber optics, including the wires that comprise bus 1502. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, flash memory device, any other memory chip or cartridge, a carrier wave as described hereinafter, or any other medium from which a computer can read.

Various forms of machine-readable media may be involved in carrying one or more sequences of one or more instructions to processor 1504 for execution. For example, the instructions may initially be carried on a magnetic disk of a remote computer. The remote computer can load the instructions into its dynamic memory and send the instructions over a data transmission line using a modem. A modem local to computer system 1500 can receive the data on the data transmission line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

Computer system 1500 also includes a communication interface 1518 coupled to bus 1502. Communication interface 1518 provides a two-way data communication coupling to a network link 1520 that is connected to a local network 1522. For example, communication interface 1518 may be an integrated services digital network (ISDN) card or other internet connection device, or a modem to provide a data communication connection to a corresponding type of data transmission line. As another example, communication interface 1518 may be a local area network (LAN) card to provide a data communication connection to a compatible LAN. Wireless network links may also be implemented. In any such implementation, communication interface 1518 sends and receives electrical, electromagnetic or optical signals that carry digital data streams representing various types of information.

Network link 1520 typically provides data communication through one or more networks to other data devices. For example, network link 1520 may provide a connection through local network 1522 to a host computer 1524 or to data equipment operated by an Internet Service Provider (ISP) 1526. ISP 1526 in turn provides data communication services through the world wide packet data communication network now commonly referred to as the Internet 1528. Local network 1522 and Internet 1528 both use electrical, electromagnetic or optical signals that carry digital data streams. The signals through the various networks and the signals on network link 1520 and through communication interface 1518, which carry the digital data to and from computer system 1500, are exemplary forms of carrier waves transporting the information.

Computer system 1500 can send messages and receive data, including program code, through the network(s), network link 1520 and communication interface 1518. In the Internet example, a server 1530 might transmit a requested code for an application program through Internet 1528, ISP 1526, local network 1522 and communication interface 1518.

The received code may be executed by processor 1504 as it is received, and/or stored in storage device 1510, or other non-volatile storage for later execution. In this manner, computer system 1500 may obtain application code in the form of a carrier wave.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Various additions, deletions and modifications are contemplated as being within its scope. The scope of the invention is, therefore, indicated by the appended claims rather than the foregoing description. Further, all changes which may fall within the meaning and range of equivalency of the claims and elements and features thereof are to be embraced within their scope.

What is claimed is:

1. A system for managing guest payment, comprising:
a data store configured to maintain at least one set of registered photos, wherein the photos include a digital image captured of a face of at least one registered user;
a communication module configured to receive an input digital photo, wherein the photo includes an image captured of a face of a payee user;
a communication module configured to receive instructions for initiating a payment transaction of an monetary amount from a payor user to the payee user whose face is captured in the input digital photo;
a comparing module configured to cause a processor to compare the input digital photo with the set of registered photos, to determine a match between the input digital photo and a matched photo of the set of registered photos; and
a processor configured to determine a registered user profile associated with the matched photo and to determine a payment receiving mode associated with the registered user profile for transferring funds from the payor user's account to the payee user according to the payment receiving mode.

2. The system of claim 1, further comprising a processor configured to detect if one or more new photos have been added to the set of registered photos, and a comparing module configured to cause a processor to compare the input digital photo with the new photos to determine a match until any one of either a match is found or a terminating event.

3. The system of claim 1, further comprising an aggregating module configured to cause the processor to aggregate a set of payments from a plurality of payment transactions for one payee user by one or more payor users, and to send the aggregated set of payments to the payee user according to the payment receiving mode in one funds transfer transaction.

4. The system of claim 1, further comprising a data store is configured to store the payor's check, and a processor configured to determine the monetary amount based on the check of the payor user.

5. The system of claim 1, wherein the registered user profile includes one or more message receiving modes of the payee user, wherein a communication module is configured to accept a message associated with the payment transaction, and the processor and communication modules are configured to transmit the message to the payee user according to the one or more message receiving modes.

6. The system of claim 1, further comprising a data store configured to store the input digital photo with a transaction identifier associated with the payment transaction and an indicator of whether the input digital photo has been matched, wherein the processor is configured to determine if one or more new photos have been added to the set of registered photos, and to compare the input digital photo with the new photos to determine a match if the indicator indicates that the input digital photo has not been matched to any registered photos.

7. A computer-implemented method for managing guest payment, comprising:
maintaining, in an electronic data store communicatively coupled to one or more server computers, at least one set of registered photos, wherein the photos include a digital image captured of a face of at least one registered user;
receiving, at a communication module on the one or more server computer, an input digital photo, wherein the photo includes an image captured of a face of a payee user;
receiving, at the communication module, instructions for initiating a payment transaction of an monetary amount from a payor user to the payee user whose face is captured in the input digital photo;
comparing, by one more processors on the one or more server computer executing instructions, the input digital photo with the set of registered photos, to determine a match between the input digital photo and a matched photo of the set of registered photos; and
determining, by the one more processors, a registered user profile associated with the matched photo, and determining a payment receiving mode associated with the registered user profile for transferring funds from the payor user's account to the payee user according to the payment receiving mode.

8. The method of claim 7, further comprising detecting if one or more new photos have been added to the set of registered photos, and comparing the input digital photo with the new photos to determine a match until any one of either a match is found or a terminating event, wherein the detecting and comparing steps are performed by the one more processors executing one more instructions on the one or more server computers.

9. The method of claim 7, further aggregating a set of payments from a plurality of payment transactions for one payee user by one or more payor users, and sending aggregated set of payments to the payee user according to the payment receiving mode in one funds transfer transaction, wherein the aggregating and sending steps are performed by the one more processors executing one more instructions on the one or more server computers.

10. The method of claim 7, further comprising the steps of:
storing the payor's check in the data store, and determining, by the one or more processors executing instructions, the monetary amount based on the check of the payor user.

11. The method of claim 7, wherein the registered user profile includes one or more message receiving modes of the payee user, and further comprising the steps of:
receiving a message associated with the payment transaction, and
transmitting the message to the payee user according to the one or more message receiving modes, wherein the receiving and transmitting steps are performed by the one more processors executing one more instructions on the one or more server computers.

12. The method of claim 7, further comprising the steps of:
storing, at the data store, the input digital photo with a transaction identifier associated with the payment transaction and an indicator of whether the input digital photo has been matched;
determining if one or more new photos have been added to the set of registered photos; and
comparing the input digital photo with the new photos to determine a match if the indicator indicates that the input digital photo has not been matched to any registered photos, wherein the determining and comparing steps are performed by the one more processors executing one more instructions on the one or more server computers.

13. A system for managing guest payment, comprising:
a communications module configured to receive location data from a mobile device of a payor user;
a processor configured to determine a set of candidate payee users;
a communications module configured to transmit identifiers for the set of candidate payee users to the mobile device of the payor user, wherein each identifier is associated with one of the payee users;
a communications module configured to receive from the payor user's mobile device a particular selected identifier associated with a selected payee user, and to receive instructions for initiating a payment transaction of an monetary amount from the payor user to the selected payee user; and
a processor configured to determine a registered user profile associated with the selected identifier and to determine a payment receiving mode associated with the registered user profile for transferring funds from the payor user's account to the selected payee user according to the payment receiving mode.

14. The system of claim 13, where the set of candidate payee users are determined based on identifying one or more mobile devices of payee users being in proximity to the mobile device of the payee user.

15. The system of claim 14, wherein the one or more mobile devices of payee users in proximity to the mobile device of the payor user are devices determined by the processor to be within a certain distance from the mobile device of the payor user.

16. The system of claim 14, wherein the one or more mobile devices of payee users in proximity to the mobile device of the payor user are devices determined by the processor to be within a geo-fenced area within which the mobile device of the payor user is located.

17. The system of claim 13, where the set of candidate payee users are determined based on identifying one or more payee users previously tipped at a location in proximity to the mobile device of the payee user.

18. The system of claim 13, further comprising a data store is configured to store the payor's check, and a processor configured to determine the monetary amount based on the check of the payor user.

19. The system of claim 13, further comprising an aggregating module configured to cause the processor to aggregate a set of payments from a plurality of payment transactions for one payee user by one or more payor users, and to send the aggregated set of payments to the payee user according to the payment receiving mode in one funds transfer transaction.

20. The system of claim 15, wherein a geo-fenced area includes an area contained within a specified physical boundary.

21. The system of claim 13, wherein the registered user profile includes one or more message receiving modes of the payee user, wherein a communication module is configured to accept a message associated with the payment transaction, and the processor and communication modules are configured to transmit the message to the payee user according to the one or more message receiving modes.

22. A computer-implemented method for managing guest payment, comprising:
receiving, at a communication module on one or more server computer, location data from a mobile device of a payor user;
determining, by one more processors on the one or more server computer executing instructions, a set of candidate payee users;
transmitting, from the one or more server computer, identifiers for the set of candidate payee users to the mobile device of the payor user, wherein each identifier is associated with one of the payee users;
receiving, at the communications module and from the payor user's mobile device, a particular selected identifier associated with a selected payee user, and receiving instructions for initiating a payment transaction of an monetary amount from the payor user to the selected payee user; and
determining a registered user profile associated with the selected identifier, and determining a payment receiving mode associated with the registered user profile for transferring funds from the payor user's account to the selected payee user according to the payment receiving mode, wherein the determining steps are performed by the one more processors executing one more instructions on the one or more server computers.

23. The method of claim 22, where the set of candidate payee users are determined based on identifying one or more mobile devices of payee users being in proximity to the mobile device of the payee user.

24. The method of claim 23, wherein the one or more mobile devices of payee users in proximity to the mobile device of the payor user are devices determined by the processor to be within a certain distance from the mobile device of the payor user.

25. The method of claim 23, wherein the one or more mobile devices of payee users in proximity to the mobile device of the payor user are devices determined by the processor to be within a geo-fenced area within which the mobile device of the payor user is located.

26. The method of claim 22, where the set of candidate payee users are determined based on identifying one or more payee users previously tipped at a location in proximity to the mobile device of the payee user.

27. The method of claim 22, further comprising the steps of:
storing, at a data store communicatively coupled to the server computer, the payor's check, and
determining, by the one or more processor executing instructions, the monetary amount based on the check of the payor user.

28. The method of claim 22, further aggregating a set of payments from a plurality of payment transactions for one payee user by one or more payor users, and sending aggregated set of payments to the selected payee user according to the payment receiving mode in one funds transfer transaction, wherein the aggregating and sending steps are performed by the one more processors executing one more instructions on the one or more server computers.

29. The method of claim 25, wherein the geo-fenced area includes an area contained within a specified physical boundary.

30. The method of claim 22, wherein the registered user profile includes one or more message receiving modes of the selected payee user, wherein a communication module is configured to accept a message associated with the payment transaction, and the processor and communication modules are configured to transmit the message to the selected payee user according to the one or more message receiving modes.
